(19) United States
(12) Patent Application Publication
(10) Pub. No.: US 2015/0245016 A1
(43) Pub. Date: Aug. 27, 2015

(54) SYSTEM AND METHOD FOR BINOCULAR HARMONIZATION

(71) Applicant: THALES VISIONIX, INC., Clarksburg, MD (US)

(72) Inventor: Robert Bozkurt ATAC, Batavia, IL (US)

(21) Appl. No.: 14/622,513

(22) Filed: Feb. 13, 2015

Related U.S. Application Data
(60) Provisional application No. 61/944,900, filed on Feb. 26, 2014.

(51) Int. Cl. H04N 13/04; H04N 13/00; G02B 27/01

(52) U.S. Cl. CPC H04N 13/044; G02B 27/0172; H04N 13/0497; H04N 13/004; G02B 2027/014; G02B 2027/0134

(57) ABSTRACT

A device, system, and method for displaying an image to a user includes receiving a first image including a first object at a first distance and a second object at a second distance from a first imaging device; receiving a second image including the first object at the first distance and the second object at the second distance from a second imaging device; measuring the first distance between the first object and the user and the second distance between the second object and the user; generating a harmonized first image and a harmonized second image by modifying the first image and the second image based on the first distance and the second distance; and displaying the harmonized first image to a first eye of the user and the harmonized second image to a second eye of the user.

### CROSS-REFERENCE TO RELATED APPLICATIONS

This application claims priority to U.S. Provisional Application Ser. No. 61/944,900 entitled “SYSTEM AND METHOD FOR BINOCULAR HARMONIZATION,” filed Feb. 26, 2014, which is assigned to the assignee hereof and expressly incorporated by reference herein in its entirety.

### BACKGROUND

The disclosure generally relates to a system and method for binocular harmonization and, in some aspects, to a system and method for warping stereoscopic images for a binocular helmet mounted display system.

### SUMMARY

According to an aspect of the disclosure, a system for displaying an image to a user may include a first imaging device configured to receive a first image of a first object at a first distance and a second object at a second distance; a second imaging device configured to receive a second image of the first object at the first distance and the second object at the second distance; a distance measurement device configured to measure the first distance between the first object and the user and the second distance between the second object and the user; a processor configured to receive the first image, the second image, the first distance and the second distance, the processor configured to generate a harmonized first image and a harmonized second image by modifying the first image and the second image based on the first distance and the second distance; and a stereoscopic display configured to display the harmonized first image to a first eye of the user and the harmonized second image to a second eye of the user.

According to another aspect of the disclosure, a method for displaying an image to a user may include receiving a first image including a first object at a first distance and a second object at a second distance from a first imaging device; receiving a second image including the first object at the first distance and the second object at the second distance from a second imaging device; measuring the first distance between the first object and the user and the second distance between the second object and the user; generating a harmonized first image and a harmonized second image by modifying the first image and the second image based on the first distance and the second distance; and displaying the harmonized first image to a first eye of the user and the harmonized second image to a second eye of the user.

According to yet another aspect of the disclosure, a system may include means for receiving a first image including a first object at a first distance and a second object at a second distance from a first imaging device; means for receiving a second image including the first object at the first distance and the second object at the second distance from a second imaging device; means for measuring the first distance between the first object and the user and the second distance between the second object and the user; means for generating a harmonized first image and a harmonized second image by modifying the first image and the second image based on the first distance and the second distance; and means for displaying the harmonized first image to a first eye of the user and the harmonized second image to a second eye of the user.

According to yet another aspect of the disclosure, a computer program product, including a non-transitory computer-readable medium having control logic stored therein for causing a computer to display an image to a user, may include code for receiving a first image including a first object at a first distance and a second object at a second distance from a first imaging device; code for receiving a second image including the first object at the first distance and the second object at the second distance from a second imaging device; code for measuring the first distance between the first object and the user and the second distance between the second object and the user; code for generating a harmonized first image and a harmonized second image by modifying the first image and the second image based on the first distance and the second distance; and code for displaying the harmonized first image to a first eye of the user and the harmonized second image to a second eye of the user.

It is understood that other aspects of the disclosure will become readily apparent to those skilled in the art from the following detailed description, wherein various aspects of the disclosure are shown and described by way of illustration only. As will be understood, aspects of the disclosure are capable of other and different variations and its several details are capable of modification in various other respects, all without departing from the scope of the disclosure. Accordingly, the drawings and detailed description are to be regarded as illustrative in nature and not as restrictive.

### BRIEF DESCRIPTION OF THE DRAWINGS

These and other sample aspects of the disclosure will be described in the detailed description and the appended claims that follow, and in the accompanying drawings, wherein:

FIG. 1 depicts a schematic diagram of a system for binocular harmonization in accordance with an exemplary aspect of the present disclosure;

FIG. 2A depicts a schematic illustration of the stereoscopic images received by the system for binocular harmonization shown in FIG. 1;

FIG. 2B depicts a schematic illustration of the stereoscopic images displayed to the user by the system for binocular harmonization shown in FIG. 1;

FIG. 3 depicts a logic flow diagram of a method for binocular harmonization in accordance with an exemplary aspect of the present disclosure; and

FIG. 4 depicts a computer system for implementing various aspects of the present disclosure.

### DETAILED DESCRIPTION

Various aspects of the present disclosure are described below. It should be apparent that the teachings herein may be embodied in a wide variety of forms and that any specific structure, function, or both being disclosed herein may be merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality, in addition to or other than one or more of the aspects set forth herein. An aspect may comprise one or more elements of a claim.

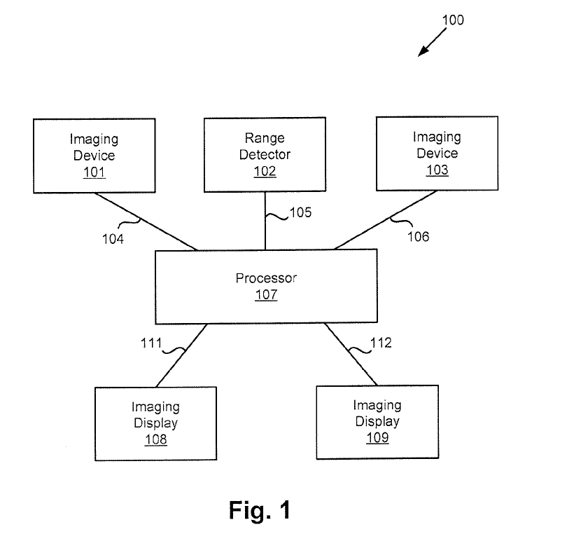

Referring to the drawings in detail, wherein like reference numerals indicate like elements throughout, there is shown in FIGS. 1-3, a system and a method for binocular harmonization, generally designated 100 and 300, in accordance with an exemplary aspect of the present disclosure. The words “system” and “method” as used herein are used interchangeably and are not intended to be limiting.

A helmet-mounted display (“HMD”) is a display device worn by a user that displays an image for a user based on a perceived image taken by a camera attached to the HMD. HMDs have many different applications ranging from virtual reality simulators to aviation applications. In one application, a binocular HMD may be used for viewing distant objects. In this application, each camera may have a collimated display, meaning the cameras are focused at infinity and the rays of received light are parallel with one another. In order to display the images to the user as a single image, the images from the cameras must be harmonized, meaning the two images appear as a single image to the user. To harmonize the images, the HMD may shift the entire position of one image rightward when viewed by the left eye and the other image leftward when viewed by the right eye so that when a user views an image, the user appears to see one image.

While this configuration may work for objects greater than 100 ft from a user, the configuration may produce a double, or misaligned, image for a user when objects are closer than 100 ft. For example, when a user views an object closer than 100 ft using the binocular HMD, the user's eyes may begin to converge. One solution may be to shift the images for each eye inward to correct the problem. However, when there are multiple objects at different distances it is difficult to know which object the user is viewing. Therefore, the system may not be able to determine how much to shift the images in order to compensate for the user's eye convergence.

In one exemplary aspect, a system 100 for binocular harmonization is provided with an improved capability to view images at different distances by harmonizing the images or, in other words, modifying the images so that when the user looks at the images they appear as a single image to the user without taking into account where the user is looking. In this aspect, no matter where the user focuses his view, the HMD produces a perceived single image for a user.

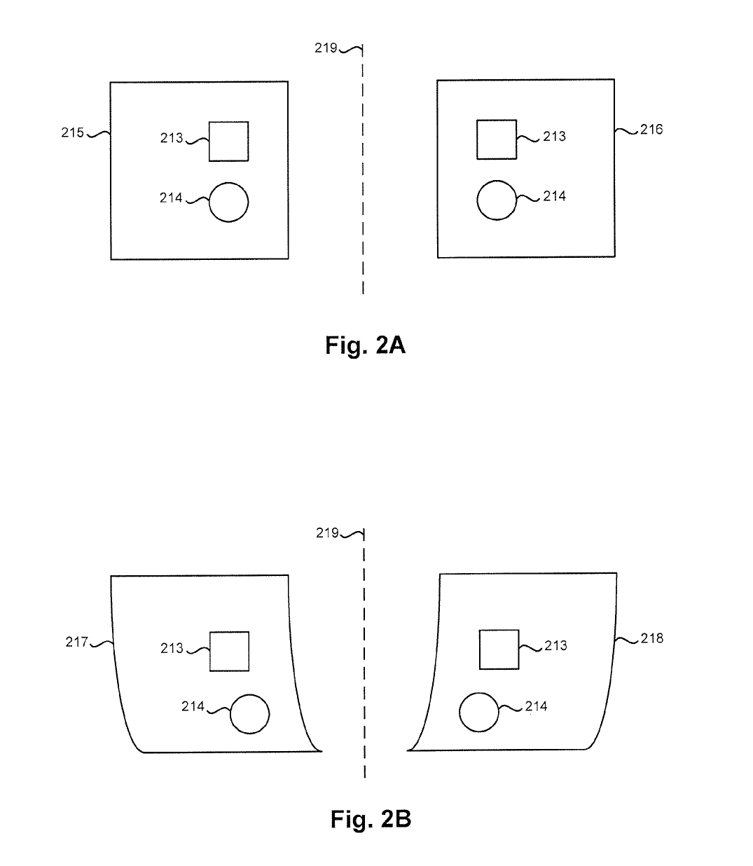

Referring to FIGS. 1, 2A and 2B, there is shown a schematic diagram of system 100 for binocular harmonization and schematic illustrations of the received and displayed images using system 100. In one aspect, first image 215 and second image 216 may be received by system 100 and harmonized. In one aspect, harmonized first image 217 and harmonized second image 218 may be displayed to a user by system 100. In one aspect, system 100 may include a first imaging device 101 configured to receive first image 215 of a first object 213 at a first distance from the user and a second object 214 at a second distance from the user. In one aspect, system 100 may include a second imaging device 103 configured to receive the second image 216 of first object 213 at the first distance and the second object 214 at the second distance. In one aspect, the distances of the first object 213 and the second object 214 may be different. In one aspect, the difference between the distances of the first object 213 and the second object 214 may be substantially large such that a binocular HMD may not focus on both the first object 213 and the second object 214 at the same time. In one aspect, the first object 213 may be at a distance greater than 100 feet. In one aspect, the second object 214 may be at a distance less than 100 feet. In one aspect, the first object 213 and the second object 214 may be both at a distance of less than 100 feet. In one aspect, the first imaging device 101 may be a camera and the second imaging device 103 may be a camera. Each of the cameras may be different types of cameras, such as a full spectrum camera, a night vision camera, Short Wave Infra Red (IR), Mid Wave IR, Long Wave IR, and any other imaging cameras. In one aspect, first imaging device 101 may be mounted to a helmet of a user. In one aspect, second imaging device 103 may be mounted to a helmet of a user. In one aspect, connection lines 104 and 106 may transmit image signals from first imaging device 101 and second imaging device 103 to an external source. In one aspect, the transmitted image signals may be real-time video signals.

In one aspect, system 100 may include a distance measuring device 102 configured to measure a first distance between first object 213 and a user, and a second distance between second object 214 and a user. In one aspect, distance measuring device 102 may be a range detector. In one aspect, distance measuring device 102 may be a laser range finder. In one aspect, distance measuring device 102 may include a radiated energy emitter that emits radiated energy towards first and second objects 213 and 214. In one aspect, distance measuring device 102 may include a radiated energy detector that receives radiated energy from first and second objects 213 and 214. In one aspect, distance measuring device 102 may calculate a distance of an object from a user by measuring the amount of time between emission and reception of a radiated energy signal and then multiplying the amount of time by the speed of light. In other aspects, the distance measuring device 102 may include other types of range finders, such as radar, laser, and may also include a module for calculating distance based on aircraft position and digital terrain elevation data, for example. In one aspect, connection line 105 may provide the distance data calculated by distance measuring device 102 to an external source.

In one aspect, system 100 may include a processor 107 configured to receive first image 215 from imaging device 101, second image 216 from imaging device 103, a distance for first object 213 from range detector 102 and a distance for second object 214 from range detector 102. In one aspect, processor 107 may be mounted to a helmet. In one aspect, processor 107 may generate a harmonized first image 217 and a harmonized second image 218 by modifying first image 215 and second image 216 based on the distance for data from range detector 102. In one aspect, processor 107 may generate harmonized first image 217 and harmonized second image 218 by modifying first image 215 and second image 216 based on a midline 219 of the user. In one aspect, processor 107 may perform a mathematical computation on each line of an image. In one aspect, processor 107 may warp at least a portion of first image 215 and second image 216 based on the distance of first object 213 and second object 214. For example, an algorithm for warping the first image 215 and the second image 216 may include the formation of a right triangle with half of the interpupillary distance on one side and the distance to the target on the other side. The angle of convergence for the eye may be ARCTAN((0.5)*IPD/range). The center of the symbol may then be shifted, and the entire symbol may then be moved the same amount. Such a binocular correction may, for example, be required only for symbols placed on objects that are within a predetermined distance of the observer (e.g., 60 feet). It may be assumed that the symbols are being placed on earth objects and that the region is reasonably uniform.

In one aspect, processor 107 may receive an input real-time video signal from imaging device 101 and imaging device 103 and may warp the real-time video signal into a different pattern or shape depending on the distance data received from range detector 102. In one aspect, processor 107 may perform mathematical computations on each real-time video line in a real-time video signal with almost no latency. In one aspect, processor 107 may process the real-time video signal at the same rate the real-time video signal is received.

In one aspect, processor 107 may modify a final position of each object 213 and 214 in first harmonized image 217 and second harmonized image 218 based on a comparison between an initial position of each object 213 and 214 in first image 215 and an initial position of each object 213 and 214 in second image 216. FIGS. 2A and 2B shows, in one aspect, the difference between received images 215 and 216 and harmonized images 217 and 218. In harmonized images 217 and 218, the position of objects 213 and 214 have moved relative to the positions in received images 215 and 216. FIGS. 2A and 2B also show that, in one aspect, the amount that first object 213 moved compared to second object 214 is different. As explained above, in at least one aspect, the amount of modification made to a portion of an image or an object is dependent on the distance of the object from a user. In one aspect, when a user views either object 213 or 214 using his foveal vision, the objects 213 or 214 will appear focused and harmonized. Therefore, system 100 may display a harmonized image to a user without tracking the position of a user's eyes.

In one aspect, processor 107 may calculate an average position between an initial position of each object 213 and 214 in first image 215 and an initial position of each object 213 and 214 in second image 216, and may modify a final position of each object 213 and 214 in first harmonized image 217 and a final position of each object 213 and 214 in second harmonized image 218 based on the average position of each object 213 and 214 in first image 215 and second image 216.

In one aspect, processor 107 may receive two different video signals from imaging device 101 and imaging device 103 and may output an imaging display signal that is a composite of the two different video signals. In one aspect, processor 107 may output two imaging display signals as a first harmonized image 217 and a second harmonized image 218. In one aspect, processor 107 may transmit the two imaging display signals to a first imaging display device 108 and a second imaging display device 109 via connection lines 111 and 112. In one aspect, first imaging display device 108 may be viewed by a first eye of a user. In one aspect, second imaging display device 109 may be viewed by a second eye of a user. In one aspect, processor 107 may include a field programmable gate array microprocessor. In one aspect, processor 107 may superimpose computer-generated symbols on first image 215 and second image 216. In one aspect, first object 213 may be a computer-generated symbol. In one aspect, second object 214 may be a computer-generated symbol.

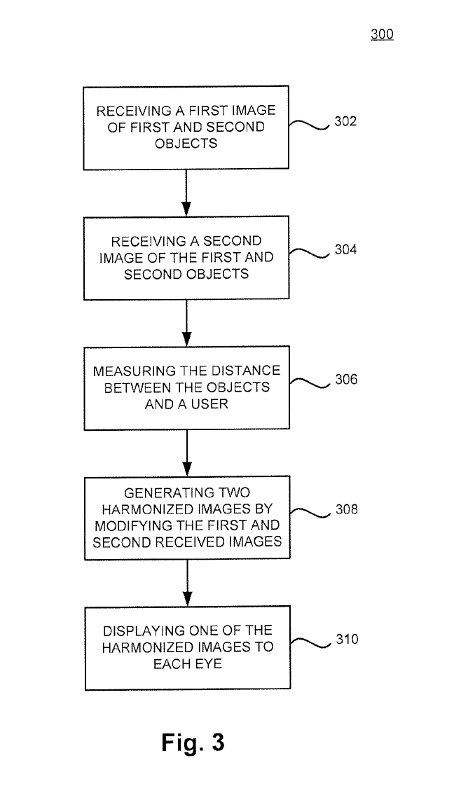

Referring to FIG. 3, there is shown a logic flow diagram illustrating method 300 for binocular harmonization. At step 302, first imaging device 101 may receive first image 215 of first object 213 at a first distance and second object 214 at a second distance from first imaging device 101.

At step 304, in one aspect, second imaging device 103 may receive second image 216 of first object 213 and second object 214 from second imaging device 103.

At step 306, in one aspect, range detector 102 may measure a first distance between first object 213 and a user and a second distance between second object 214 and the user.

At step 308, in one aspect, processor 107 may generate harmonized first image 217 and harmonized second image 218 by modifying first image 215 and second image 216 based on the distance between the first object 213 and the user and the other distance between second object 214 and the user, as described above in more detail.

At step 310, in one aspect, first imaging display 108 may display harmonized first image 217 to a first eye of the user and harmonized second image 218 to a second eye of the user.

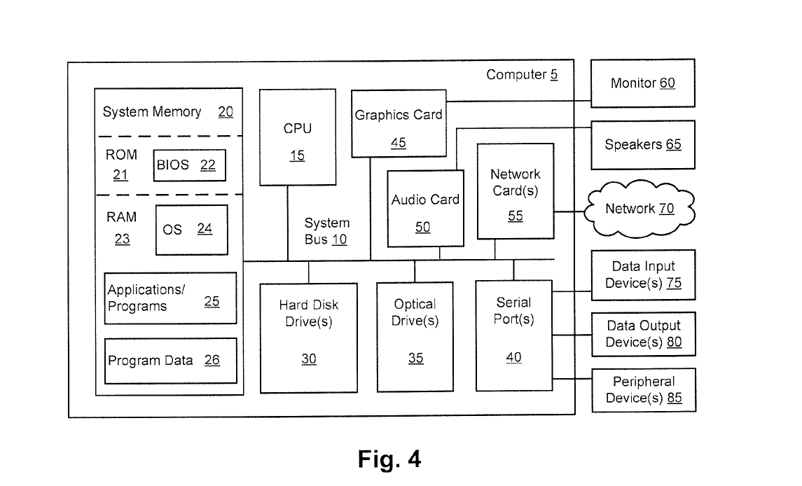

FIG. 4 depicts one example aspect of a computer system 5 that may be used to implement the disclosed systems and methods providing binocular harmonization according to one aspect of the disclosure. The computer system 5 may include, but is not limited to, a personal computer, a notebook, tablet computer, a smart phone, a mobile device, a network server, a router, or other type of processing device. As shown, computer system 5 may include one or more hardware processors 15, memory 20, one or more hard disk drive(s) 30, optical drive(s) 35, serial port(s) 40, graphics card 45, audio card 50 and network card(s) 55 connected by system bus 10. System bus 10 may be any of several types of bus structures including a memory bus or memory controller, a peripheral bus and a local bus using any of a variety of known bus architectures. Processor 15 may include one or more Intel® Core 2 Quad 2.33 GHz processors or other type of microprocessor.

System memory 20 may include a read-only memory (ROM) 21 and random access memory (RAM) 23. Memory 20 may be implemented as in DRAM (dynamic RAM), EPROM, EEPROM, Flash or other type of memory architecture. ROM 21 stores a basic input/output system 22 (BIOS), containing the basic routines that help to transfer information between the modules of computer system 5, such as during start-up. RAM 23 stores operating system 24 (OS), such as Windows® 7 Professional or other type of operating system, that is responsible for management and coordination of processes and allocation and sharing of hardware resources in computer system 5. Memory 20 also stores applications and programs 25. Memory 20 also stores various runtime data 26 used by programs 25.

Computer system 5 may further include hard disk drive(s) 30, such as SATA HDD, and optical disk drive(s) 35 for reading from or writing to a removable optical disk, such as a CD-ROM, DVD-ROM or other optical media. Drives 30 and 35 and their associated computer-readable media provide non-volatile storage of computer readable instructions, data structures, applications and program modules/subroutines that implement algorithms and methods disclosed herein. Although the exemplary computer system 5 employs magnetic and optical disks, it should be appreciated by those skilled in the art that other types of computer readable media that can store data accessible by a computer system 5, such as magnetic cassettes, flash memory cards, digital video disks, RAMs, ROMs, EPROMs and other types of memory may also be used in alternative aspects of the computer system 5.

Computer system 5 further includes a plurality of serial ports 40, such as Universal Serial Bus (USB), for connecting data input device(s) 75, such as keyboard, mouse, touch pad and other. Serial ports 40 may be also be used to connect data output device(s) 80, such as printer, scanner and other, as well as other peripheral device(s) 85, such as external data storage devices and the like. System 5 may also include graphics card 45, such as nVidia® GeForce® GT 240M or other video card, for interfacing with a display 60 or other video reproduction device, such as touch-screen display. System 5 may also include an audio card 50 for reproducing sound via internal or external speakers 65. In addition, system 5 may include network card(s) 55, such as Ethernet, WiFi, GSM, Bluetooth® or other wired, wireless, or cellular network interface for connecting computer system 5 to network 70, such as the Internet.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

Further, to the extent that the method does not rely on the particular order of steps set forth herein, the particular order of the steps should not be construed as limitation on the claims. The claims directed to the method of the present disclosure should not be limited to the performance of their steps in the order written, and one skilled in the art can readily appreciate that the steps may be varied and still remain within the spirit and scope of the present disclosure.

1. A system for displaying an image to a user, the system comprising:
a first imaging device configured to receive a first image of a first object at a first distance and a second object at a second distance;
a second imaging device configured to receive a second image of the first object at the first distance and the second object at the second distance;
a distance measurement device configured to measure the first distance between the first object and the user and the second distance between the second object and the user;
a processor configured to receive the first image, the second image, the first distance and the second distance, wherein the processor is further configured to generate a harmonized first image and a harmonized second image by modifying the first image and the second image based on the first distance and the second distance; and
a stereoscopic display configured to display the harmonized first image to a first eye of the user and the harmonized second image to a second eye of the user.

2. The system of claim 1, wherein the first object is a first computer-generated symbol and the second object is a second computer-generated symbol.

3. The system of claim 2, wherein the first symbol is superimposed on the first and second image, and wherein the second symbol is superimposed on the first and second image.

4. The system of claim 3, wherein the processor calculates an average position of each symbol in the first image and each corresponding symbol in the second image, and modifies a final position of each symbol in the first and second harmonized images based on the average position between each symbol in the first image and each corresponding symbol in the second image.

5. The system of claim 1, wherein the processor modifies a final position of each object in the first harmonized image and a final position of each object in the second harmonized image based on a comparison between an initial position of each object in the first image and an initial position of each object in the second image.

6. The system of claim 5, wherein the processor calculates an average position between the initial position of each object in the first image and the initial position of each object in the second image, and modifies the final position of each object in the first harmonized image and the final position of each object in the second harmonized image based on the average position.

7. The system of claim 1, wherein the first and second imaging devices include at least one of a camera and an imaging sensor configured for at least one of full spectrum, Short Wave Infra Red (IR), Mid Wave IR, and Long Wave IR imaging.

8. The system of claim 1, wherein the distance measurement device is further configured to calculate the first distance and the second distance based at least on one of an aircraft position, a head position of a user, and digital terrain elevation.

9. The system of claim 1, wherein the first imaging device, the second imaging device, the distance measurement device and the processor are mounted on a helmet.

10. The system of claim 1, wherein the first imaging device and the second imaging device are each further configured to receive a plurality of images of a plurality of objects each located at different distances.

11. A method for displaying an image to a user, the method comprising:
receiving a first image including a first object at a first distance and a second object at a second distance from a first imaging device;
receiving a second image including the first object at the first distance and the second object at the second distance from a second imaging device;
measuring the first distance between the first object and the user and the second distance between the second object and the user;
generating a harmonized first image and a harmonized second image by modifying the first image and the second image based on the first distance and the second distance; and
displaying the harmonized first image to a first eye of the user and the harmonized second image to a second eye of the user.

12. A system, comprising:
means for receiving a first image including a first object at a first distance and a second object at a second distance from a first imaging device;
means for receiving a second image including the first object at the first distance and the second object at the second distance from a second imaging device;
means for measuring the first distance between the first object and the user and the second distance between the second object and the user;
means for generating a harmonized first image and a harmonized second image by modifying the first image and the second image based on the first distance and the second distance; and
means for displaying the harmonized first image to a first eye of the user and the harmonized second image to a second eye of the user.

13. A computer program product comprising a non-transitory computer-readable medium having control logic stored therein for causing a computer to display an image to a user, comprising:
code for receiving a first image including a first object at a first distance and a second object at a second distance from a first imaging device;
code for receiving a second image including the first object at the first distance and the second object at the second distance from a second imaging device;
code for measuring the first distance between the first object and the user and the second distance between the second object and the user;
code for generating a harmonized first image and a harmonized second image by modifying the first image and the second image based on the first distance and the second distance; and
code for displaying the harmonized first image to a first eye of the user and the harmonized second image to a second eye of the user.
